(19) United States
(12) Patent Application Publication
(10) Pub. No.: US 2010/0298453 A1
(43) Pub. Date: Nov. 25, 2010

(54) BOARD STOCK FOAM HAVING BIOBASED CONTENT

(75) Inventors: CARINA ARAULLO MCADAMS, Wilmington, NC (US); Eugen Gnedin, Viersen (DE); Leon J. Garcia, Wilmington, NC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.A R.L., Wilmington, DE (US)

(21) Appl. No.: 12/693,661

(22) Filed: Jan. 26, 2010

Related U.S. Application Data
(60) Provisional application No. 61/147,456, filed on Jan. 26, 2009.

(51) Int. Cl. C08L 75/04; C08K 5/10; C09K 3/00; C08G 63/02

(52) U.S. Cl. 521/97; 252/182.28; 521/137; 521/182; 521/131

(57) ABSTRACT

Embodiments of the present disclosure can include polyurethane or polyisocyanurate board stock foam having a biobased content of 7% or greater as measured by ASTM D6866. In addition, embodiments of the present disclosure relate to the use of renewable material for producing aromatic polyesters polyols and/or resins to generate foam products having biobased content.

### CROSS-REFERENCE TO RELATED APPLICATION

This application claims priority to copending U.S. provisional application entitled “POLYOL AND POLYMER COMPOSITION FOR USE IN BOARD STOCK FOAM,” having Ser. No. 61/147,546, filed Jan. 27, 2009, which is entirely incorporated herein by reference.

### FIELD OF THE INVENTION

The disclosures herein relate to a polyisocyanurate (PIR) polymer with renewable (biobased) content and adapted for use in foam board stock applications.

### BACKGROUND OF THE INVENTION

There exists a significant level of interest in nonpetroleum based polyols for manufacture of rigid foams over the last five years. Government initiatives which give purchasing preferences to products containing biobased components and/or non-petroleum materials are in place. In the United States, the Code of Federal Regulations (CFR Title 7 Part 2902) details guidelines for designating biobased products for federal procurement. In this guideline, the preferred procurement product must have a biobased content of at least 7 percent, based on the amount of qualifying biobased carbon in the product as a percent of the weight (mass) of the total organic carbon in the finished product. The guideline is specifically for spray-in-place plastic foam products designed to provide a sealed thermal barrier for residential or commercial construction applications.

In the area of rigid foams, commercially available natural oil based polyols used for both pour-in-place and spray foams are known. These polyols include natural oil based products made with edible (comestible) oils from plant sources such as soybean oil or corn oil and derivatized substituents thereof. As a result, a concern for the use of edible oils in the production of industrial products and their competition with food products exists.

### SUMMARY OF THE INVENTION

Embodiments of the present disclosure can include polyurethane or polyisocyanurate board stock foams having a biobased content of 7% or greater as measured by ASTM D6866. In addition, embodiments of the present disclosure relate to the use of renewable material for producing aromatic polyesters polyols and/or resins to generate foam products having biobased content.

Embodiments of the present disclosure can include polyurethane or polyisocyanurate board stock foam having a biobased content of 7% or greater as measured by ASTM D6866 that can be made from an aromatic polyol (e.g., a biobased polyol composition) and resin. In an embodiment, the polyurethane or polyisocyanurate board stock foam having a biobased content of 7% or greater as measured by ASTM D6866 includes a foam having an aromatic polyol provided by the reaction products of: a first composition comprising a hydroxylated material, wherein the hydroxylated material is at least difunctional; a second composition selected from the group consisting of: terephthalic acid, an ester of terephthalic acid, isophthalic acid, an ester of isophthalic acid, orthophthalic acid, an ester of orthophthalic acid, trimellitic acid, an ester of trimellitic acid, orthophthalic anhydride, an ester of orthophthalic anhydride, trimellitic anhydride, an ester of trimellitic anhydride, and a mixture thereof; and a third composition comprising of up to 50% of a hydrophobic material, wherein the hydrophobic material is selected from the group consisting of: a nonedible plant derived oil, a nonedible animal derived oil, a fatty acid of a nonedible plant oil, a fatty acid of an animal derived oil, an ester of a nonedible plant oil, an ester of a nonedible animal derived oil, and a mixture thereof.

One exemplary polyol composition, among others, includes a first composition comprising a hydroxylated material, wherein the hydroxylated material is at least difunctional; a second composition selected from the group consisting of: terephthalic acid, an ester of terephthalic acid, isophthalic acid, an ester of isophthalic acid, orthophthalic acid, an ester of orthophthalic acid, trimellitic acid, an ester of trimellitic acid, orthophthalic anhydride, an ester of orthophthalic anhydride, trimellitic anhydride, an ester of trimellitic anhydride, and a mixture thereof; and a third composition comprising of up to 50% of a hydrophobic material, wherein the hydrophobic material is selected from the group consisting of: a nonedible plant derived oil, a nonedible animal derived oil, a fatty acid of a nonedible plant oil, a fatty acid of an animal derived oil, an ester of a nonedible plant oil, an ester of a nonedible animal derived oil, and a mixture thereof.

One exemplary resin blend, among others, includes an aromatic polyol, a surfactant, a catalyst and a blowing agent.

### BRIEF DESCRIPTION OF THE DRAWINGS

FIG. 1 shows hydroxyl values and viscosity as a function of hydrophoblic modification for one composition of the invention.

FIG. 2 is a boxplot of hydrocarbon solubility in various polyol resins including one aromatic polyol and two aliphatic polyols.

FIG. 3 illustrates friability data as a function of aromatic vs. aliphatic content the polyol constituent of the isocyanurate foam.

FIG. 4 shows the number of test cycles prior to 25% delamination for isocyanurate foams containing aromatic vs. aliphatic polyols.

FIG. 5 is a matrix plot showing the effect of density and humid age on compressive strength of an isocyanurate foam.

FIG. 6 is a matrix plot of initial k factor and the six-month k-factor change, both as a function of aromaticity of polyol in an isocyanurate foam, with k factor being inversely proportional to thermal insulating value.

FIG. 7 is a matrix plot showing foam burn properties as a function of aromaticity of polyol in an isocyanurate foam.

FIG. 8 is plot showing the effect of composition of three-component pentane isomer blowing agents in isocyanurate foam.

FIG. 9 is a plot showing the density achievable as a function of composition of three-component pentane isomer blowing agents in isocyanurate foam.

FIG. 10 is a plot showing the normalized average compressive strength as a function of composition of three-component pentane isomer blowing agents in isocyanurate foam.

FIG. 11 is a plot showing the humidity aging as a function of composition of three-component pentane isomer blowing agents in isocyanurate foam.

FIG. 12 is a plot showing k factor as a function of composition of three-component pentane isomer blowing agents in isocyanurate foam.

FIG. 13 is a is a plot showing fire resistance under the standard FM-4450 as a function of composition of three-component pentane isomer blowing agents in isocyanurate foam.

FIG. 14 includes Table I.

FIG. 15 includes Table II.

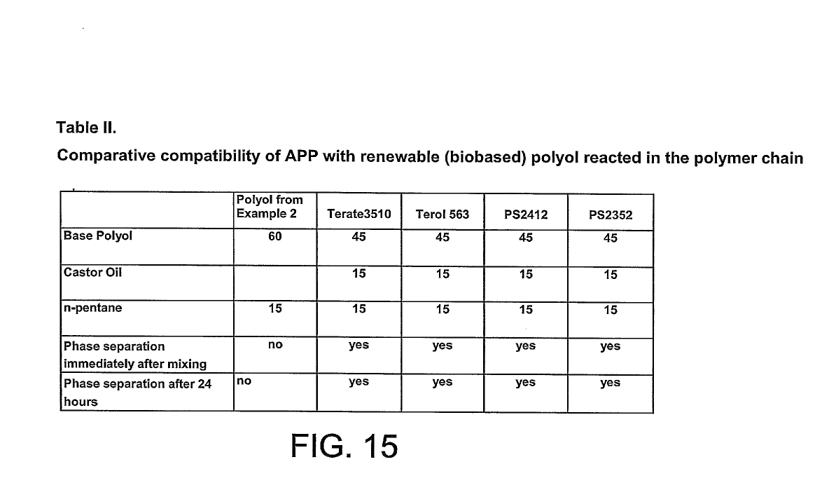

FIG. 16 includes Table III.

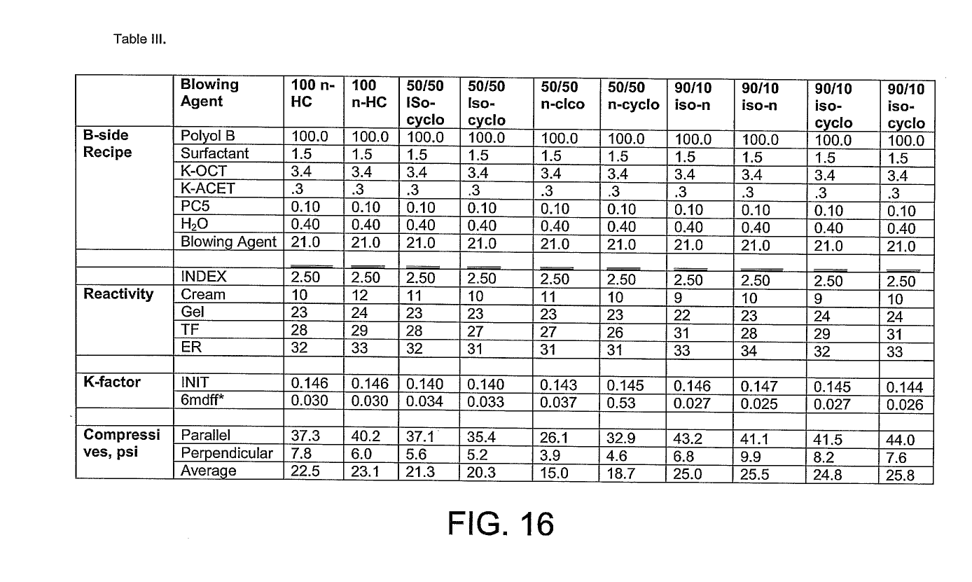

### DETAILED DESCRIPTION OF THE INVENTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, foam chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

As used in this specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions:

A “board stock foam” is a product of a polyol composition and a polyisocyanate composition which are foamable. The board stock foam can be a polyurethane or polyisocyanurate board stock foam. Foamable means the resulting board stock has a cell structure produced by an expansion process. This process is known as “foaming” and provides a board stock product of comparatively low weight per unit volume and with low thermal conductivity. The foaming process can be carried out substantially simultaneously with the production of the board stock foam. Board stock foam are often used as insulators for noise abatement and/or as heat insulators in construction, in cooling and heating technology (e.g., household appliances), for producing composite materials (e.g., sandwich elements for roofing and siding), and for wood simulation material, model-making material, and packaging.

The term “hydroxyl functionality” refers to the —OH group on a molecule; e.g., methanol (CH₃OH) has a single hydroxyl functionality or functional group per molecule.

The term “hydroxyl value” refers to the concentration of hydroxyl groups, per unit weight of the polyol composition able to react with an isocyanate groups.

The term “hydroxyl number” formerly measured according to the standard ASTM D 1638 and reported as milligrams KOH/gram of the composition is measured according to ASTM D6342-08 Standard Practice for Polyurethane Raw Materials: Determining Hydroxyl Number of Polyols by Near Infrared (NIR) Spectroscopy

The term “acid number” correspondingly indicates the concentration of carboxylic acid groups present in the polyol, and is reported in terms of mg KOH/g and measured according to standard ASTM 4662-08.

The term “isocyanate” relates to a reactive chemical functional group comprising a nitrogen atom, a carbon atom, and an oxygen atom (e.g., —N═C═O); all attached to a chemical compound.

The term “isocyanate” may also refer to a chemical compound containing an isocyanate functional group.

The term “polyisocyanate” refers to a chemical compound containing more than one isocyanate functional groups.

The term “isocyanate index” relates to a measure of the stoichiometric balance between the equivalents of isocyanate functionalities and hydroxyl functionalities in a mixture of reactants. The isocyanate index is 100 times the number of isocyanate functionalities divided by the number of hydroxyl functionalities.

The term “average functionality”, or “average hydroxyl functionality” of a polyol indicates the number of OH groups per molecule, on average. The average functionality of an isocyanate refers to the number of —NCO groups per molecule, on average.

The term “aliphatic group” refers to a saturated or unsaturated linear or branched hydrocarbon group and encompasses alkyl, alkenyl, and alkynyl groups, for example.

The terms “alk” or “alkyl” refer to straight or branched chain hydrocarbon groups having 1 to 12 carbon atoms, preferably 1 to 8 carbon atoms, such as methyl, ethyl, n-propyl, i-propyl, n-butyl, i-butyl, t-butyl, pentyl, hexyl, heptyl, n-octyl, dodecyl, octadecyl, amyl, 2-ethylhexyl, and the like. An alkyl group is optionally substituted, unless stated otherwise, with one or more groups, selected from aryl (optionally substituted), heterocyclo (optionally substituted), carbocyclo (optionally substituted), halo, hydroxy, protected hydroxy, alkoxy (e.g., C₁ to C₇) (optionally substituted), acyl (e.g., C₁ to C₇), aryloxy (e.g., C₁ to C₇) (optionally substituted), alkylester (optionally substituted), arylester (optionally substituted), alkanoyl (optionally substituted), aroyl (optionally substituted), carboxy, protected carboxy, cyano, nitro, amino, substituted amino, (monosubstituted)amino, (disubstituted)amino, protected amino, amido, lactam, urea, urethane, sulfonyl, and the like.

The term “alkenyl” refers to straight or branched chain hydrocarbon groups having 2 to 12 carbon atoms, preferably 2 to 4 carbon atoms, and at least one double carbon to carbon bond (either cis or trans), such as ethenyl. An alkenyl group is optionally substituted, unless stated otherwise, with one or more groups, selected from aryl (including substituted aryl), heterocyclo (including substituted heterocyclo), carbocyclo (including substituted carbocyclo), halo, hydroxy, alkoxy (optionally substituted), aryloxy (optionally substituted), alkylester (optionally substituted), arylester (optionally substituted), alkanoyl (optionally substituted), aroyl (optionally substituted), cyano, nitro, amino, substituted amino, amido, lactam, urea, urethane, sulfonyl, and the like.

The term “alkynyl” refers to straight or branched chain hydrocarbon groups having 2 to 12 carbon atoms, preferably 2 to 4 carbon atoms, and at least one triple carbon to carbon bond, such as ethynyl. An alkynyl group is optionally substituted, unless stated otherwise, with one or more groups, selected from aryl (including substituted aryl), heterocyclo (including substituted heterocyclo), carbocyclo (including substituted carbocyclo), halo, hydroxy, alkoxy (optionally substituted), aryloxy (optionally substituted), alkylester (optionally substituted), arylester (optionally substituted), alkanoyl (optionally substituted), aroyl (optionally substituted), cyano, nitro, amino, substituted amino, amido, lactam, urea, urethane, sulfonyl, and the like.

The terms “noncomesitble” and “nonedible” refer to food or industrial sources where the item is not fit to be eaten by a mammal (specifically a human), not edible, is inedible, is not a foodstuff, or is not appropriate or safe to be eaten by a mammal (specifically a human). These terms do not mean that the item is poisonous to a human, although the item can be poisonous a human. These terms can include items that are not easily digested and/or tolerated by humans.

Pressures reported as pounds per square inch gauge (psig) are relative to one atmosphere. 1 pound per square inch=6.895 kilopascal. One atmosphere is equivalent to 101.325 kilopascals, and one atmosphere is about 14.7 pounds per square inch absolute (psia) or about 0 pounds per square inch gauge (psig).

### Discussion:

Embodiments of the present disclosure can include polyurethane or polyisocyanurate board stock foams having a biobased content of 7% or greater as measured by ASTM D6866. In addition, embodiments of the present disclosure relate to the use of renewable material for producing aromatic polyesters polyols and/or resins to generate foam products having biobased content. More specifically, these renewable aforementioned aromatic polyester polyols are from nonfood (noncomesitble) grades sources and/or nonedible industrial sources. Edible oils may include canola, corn, cottonseed, olive, peanut, rice bran, safflower seed, sesame seed, soybean, sunflower seed, coconut and palm. Nonedible sources may include industrial oils such as castor, linseed, oiticica, rapeseed, tall oils and tung oil. Nonedible sources may also include inedible tallow and grease or lard.

Embodiments of the present disclosure include polyurethane or polyisocyanurate board stock foam having a biobased content of 7% or greater as measured by ASTM D6866, aromatic polyols (also referred to as biobased polyol or biobased polyol composition), methods of making biobased polyol compositions, methods of using biobased polyol compositions, biobased resin blend compositions, methods of making biobased resin blend compositions, methods of using biobased resin compositions, biobased board stock foam compositions, biobased board stock foams, and the like. ASTM D6866-08 includes Standard Test Methods for Determining the Biobased Content of Solid, Liquid, and Gaseous Samples Using Radiocarbon Analysis.

Embodiments of the present disclosure can include polyurethane or polyisocyanurate board stock foam having a biobased content of 7% or greater as measured by ASTM D6866 that can be made from an aromatic polyol and resin. In an embodiment, the polyurethane or polyisocyanurate board stock foam having a biobased content of 7% or greater as measured by ASTM D6866 includes a foam having an aromatic polyol provided by the reaction products of: a first composition comprising a hydroxylated material, wherein the hydroxylated material is at least difunctional; a second composition selected from the group consisting of: terephthalic acid, an ester of terephthalic acid, isophthalic acid, an ester of isophthalic acid, orthophthalic acid, an ester of orthophthalic acid, trimellitic acid, an ester of trimellitic acid, orthophthalic anhydride, an ester of orthophthalic anhydride, trimellitic anhydride, an ester of trimellitic anhydride, and a mixture thereof; and a third composition comprising of up to 50% of a hydrophobic material, wherein the hydrophobic material is selected from the group consisting of: a nonedible plant derived oil, a nonedible animal derived oil, a fatty acid of a nonedible plant oil, a fatty acid of an animal derived oil, an ester of a nonedible plant oil, an ester of a nonedible animal derived oil, and a mixture thereof.

In an embodiment of the biobased polyol composition, included is an aromatic polyol, e.g., aromatic polyester polyol (APP), and provided by the reaction products of the first composition, the second composition, and the third composition, as described above.

The third composition may include a biobased component used to form the polyurethane or polyisocyanurate board stock foam. In this regard, where a third composition is provided, the disclosure provides a biobased polyol composition, a biobased resin blend composition, or a biobased foamable product derived from any of these. More particularly, a third composition may be included in an appropriate amount to provide the end product, e.g., a biobased board stock foam, with a biobased content. Such a biobased content may be chosen to be greater than 7% for a typical foam product.

In an embodiment the third composition can be about 15% to 50%, for example, or about 20% to 30% by weight of the polyol composition.

In an embodiment the third composition can be present in an amount so that the polyol composition has a biobased content of about 15% to 50%, for example, or about 20% to 30% by weight of the polyol composition.

In an embodiment, the biobased component can be less than about 50%, less than about 40%, less than about 30%, or less than about 20%, by weight of the third composition.

In an embodiment, the biobased component can be about 7% to 50%, for example, or about 7% to 30% by weight of the third composition.

In an embodiment, the biobased component is covalently bonded to the backbone of the polyol. In an embodiment, the polyol is an aromatic polyester polyol having aromatic ester linkages. The biobased component, e.g., a natural oil, is bonded via the ester linkage to the polyol backbone. Such biobased natural oil components may include: castor, linseed, oiticica, rapeseed, tall oils and tung oils; and such materials as inedible tallow and grease or lard.

In an embodiment, the third composition can include hydrophobic materials selected from the group of natural oils, as above, their corresponding fatty acids (e.g., tall oil fatty acid (TOFA), their corresponding fatty acid esters (e.g., methyl ester of TOFA) and mixtures thereof. In particular, the hydrophobic material includes one or more of the following: nonedible plant derived oils, e.g., tung oil, linseed oil, oiticica oil, dehydrated castor oil; animal derived oils, e.g., tallow; and edible plant derived oils, e.g., corn, cottonseed, olive, peanut, rice bran, safflower seed, sesame seed, soybean, sunflower seed, coconut, palm and canola (rapeseed oil).

In an embodiment, the second composition can include includes compounds such as terephthalic acid, isophthalic acid, orthophthalic acid, trimellitic acid, orthophthalic anhydride, trimellitic anhydride, and their corresponding esters (e.g., esters of terephthalic acid, esters of isophthalic acid, and the like), and mixtures thereof. In an embodiment, the second composition can be about 10% to 60% or preferably about 30% to 45% by weight of the polyol composition.

In an embodiment, the first composition can be a hydroxylated material having a functionality of at least 2 or about 2 to 10. In an embodiment, the hydroxylated material is difunctional. In an embodiment, the hydroxylated material can include ethylene glycol, diethylene glycol, triethylene glycol, tetraethyleneglycol, pentaethyleneglycol, dipropylene glycol, butanediol, and the like, or mixtures thereof. In an embodiment the first composition is about 25% to 60% or preferably about 30% to 40% by weight of the polyol composition. In an embodiment, the first composition can contain monofunctional hydroxylated material from about 0 to 5% by weight of the polyol composition.

In an embodiment, the polyol composition used to form the polyurethane or polyisocyanurate board stock foam can also include a reaction product with a hydroxylated crosslinker. The hydroxylated crosslinker can include glycerin, trimethylol, pentaerythritol, sucrose, sorbitol, and a combination thereof. In an embodiment the hydroxylated crosslinker is about 0% (or 0.01%) to 15% or about 0% (or 0.01%) to 6% by weight of the polyol composition.

In an embodiment, the polyol composition can be used in conjunction with a surfactant to form the polyurethane or polyisocyanurate board stock foam. The surfactant can include silicone based surfactants, organic based surfactants, and a mixture thereof. The silicone based surfactant can include, but is not limited to, polydimethylsiloxane-polyalkylene block copolymers and a combination thereof. In an embodiment, the surfactant serves to regulate the cell structure of the foam by helping to control the cell size in the foam and reduce the surface tension during foaming via reaction of the aromatic polyesterpolyol and, optionally, other components, with an organic polyisocyanate. Surfactants such as silicone-polyoxyalkylene block copolymers, nonionic polyoxyalkylene glycols and their derivatives, and ionic organic salts of these surfactants can be used. In particular, surfactants such as polydimethylsiloxane-polyoxyalkylene block copolymers under the trade names Dabco™ DC-193 and Dabco™ DC-5315 (Air Products and Chemicals, Allentown, Pa.), or Tegostab B8871 (EVONIK) ether sulfates, fatty alcohol sulfates, sarcosinates, amine oxides, sulfonates, amides, sulfo-succinates, sulfonic acids, alkanol amides, ethoxylated fatty alcohol, and nonionics such as polyalkoxylated sorbitan, and a combination thereof, can be used. In an embodiment, the amount of surfactant in the composition can be about 1 wt % to 4 wt %, based on the total weight of the mixture. In an embodiment, the amount of surfactant in the composition can be about 0.1 wt % to 5 wt %, based on the total weight of the mixture. In an embodiment, the amount of surfactant in the composition can be about 1 wt % to 2 wt %, based on the total weight of the mixture.

In an embodiment, the polyol composition can be used in conjunction with a catalyst to form the polyurethane or polyisocyanurate board stock foam. The catalyst can include a metal-based catalyst, amine-based catalyst, and a mixture thereof. The metal-based catalyst can include, but is not limited to, potassium octoates, potassium acetates, organomercury, organolead, organoferric, organotin catalysts (e.g., stannous octoate and dibutyltin dilaurate), and/or combination thereof. The amine-based catalyst can include, but is not limited to, triethylenediamine, N-methylmorpholine, pentamethyldiethylenetriamine, dimethylcyclohexylamine, tetra-methylethylenediamine, 1-methyl-4-dimethylaminoethyl-piperazine, 3-methoxy-N-dimethyl-propylamine, N-ethylmorpholine, diethylethanolamine, N-cocomorpho-line, N,N-dimethyl-N′,N′-dimethylisopropyl-propylene diamine, N,N-diethyl-3-diethyl aminopropylamine, dimethyl-benzyl amine, and a combination thereof. In an embodiment, the catalyst is about 1% to 5% of the mixture.

In an embodiment, the polyol composition can be used in conjunction with a blowing agent to form the polyurethane or polyisocyanurate board stock foam. The blowing agents can be a hydrocarbon having C₃ to C₇ carbon atoms, a hydrofluorocarbon, water, carbon dioxide, and a mixture thereof. The hydrocarbon can include propane, butane, pentane (e.g., iso-pentane), hexane, and their corresponding isomers, alkene analogues, and/or a combination thereof. The hydrofluorocarbon can include 1,1,1,3,3-pentafluoropropane (HFC-245fa), 1,1,1,2-tetrafluoroethane (HCF-134a), 1,1-dichloro-1-fluoroethane (HCFC 141-B), chlorodifluoromethane (HCFC R-22), HFC-365M and combinations thereof. In an embodiment, the blowing agent includes iso-pentane. In an embodiment, the blowing agent includes is about 50 to 100 weight percent of the mixture.

A wide variety of co-blowing agents can be employed in conjunction with the hydrogen-containing agents in preparing the foam compositions of the invention. Co-blowing agents can include water, air, nitrogen, carbon dioxide, readily volatile organic substances, and compounds which decompose to liberate gases (e.g., azo compounds). Typical co-blowing agents have a boiling point −50° C. to 100° C., preferably from −50° C. to 50° C. In an embodiment, iso-pentane, n-pentane, cyclopentane or combinations is the blowing agent.

In an embodiment, the blowing agent can be made from any of the three classes of blowing agents and systems used to make polyurethane and polyisocyanurate foams which are well known in the art: the HCFC/HFC or HCFC/HFC/water co-blown system; a water/hydrocarbon co-blown system; and a water blown system (also referred to in the art as a carbon dioxide blown system since CO₂ is derived from the water-isocyanate reaction). In the HCFC/HFC system, a liquid blowing agent is added to a mixture of aromatic polyesterpolyol, catalysts, and surfactants prior to adding a polyisocyanate. In the water blown system, water is added and mixed with an aromatic polyester polyol, catalyst, and surfactant mixture prior to adding a polyisocyanate. In the water and hydrocarbon co-blown system, both water and hydrocarbon blowing agents are added to an aromatic polyester polyol, catalyst surfactant premix prior to adding a polyisocyanate. The full-scale production of these components may be metered directly in to the mixing head of the foam machine or premixed with an aromatic polyester polyol stream prior to injecting into the mixing head.

As mentioned above, embodiments of the present disclosure include board stock foam compositions that include a reaction product of the biobased composition (or a mixture of components as noted above) with a polyfunctional isocyanate. In an embodiment the polyol composition is present in an amount so that the board stock foam formed from the board stock foam composition can have a biobased value content of about 7% to 25% or 7%.

The polyisocyanate component employed in the foam forming process can be any of the polyisocyanates known to be useful in the art of polymer formation. Typical polyisocyanates include m-phenylene diisocyanate; p-phenylene diisocyanate; polymethylene polyphenylisocyanate; 2,4-toluene diisocyanate; 2,6-tolylene diisocyanate; dianisidine diisocyanate; naphthalene 1,4 diisocyanate; diphenylene-4,4′-diisocyanate; aliphatic-aromatic diisocyanates, such as xylylene-1,4-diisocyanate; xylylene-1,2-diisocyante; xylylene-1,3-diisocyanate; bis(4-isocyanatophenyl) methane; bis(3-methyl-4-isocyanatophenyl) methane; and 4,4′-diphenyl propane diisocyante.

As noted above, embodiments of the present disclosure include polyurethane (PU) and/or polyisocyanurate (PIR) foams to form polyurethane or polyisocyanurate board stock foam having a biobased content of 7 per cent or greater as measured by ASTM D6866. In an embodiment, the PU and/or PIR foam and products (board stock foam) can be produced at various volume ratios of polyol composition and/or other components, and polyisocyanate. The ratios are normally referred to as A:B where “A” (or A-side component) is the polyisocyanate and “B” (or B-side component) is the polyol blend. In an embodiment, the ratio can be about 1:1 to 3:1. In an embodiment the polyol composition is present in an amount so that the board stock foam produced from the PU and/or PIR foam has a biobased content of about 7% to 25% or 7%. In an embodiment, the board stock foam formed from the PU and/or PIR spray foam has a biobased content of 7 per cent and greater as measured by ASTM D6866.

### EXAMPLES

The following examples are provided to illustrate the present disclosure. The examples are not intended to limit the scope of the present disclosure and should not be so interpreted.

Aromatic polyester polyols are polyols with aromatic ester linkages. The “biobased” aromatic polyester polyol of the invention include aromatic polyester polyols with ester linkages containing structures from natural oils and/or an aliphatic group of natural oils. As shown in an example below, a polyester polyol modified with tall oil fatty acid (TOFA) provides an ester linkage from natural source. In such a polyol, the TOFA is reacted with diethylene glycol (DEG) and 1,4-benzenedicarboxylic acid dimethyl ester, at a temperature of 235 degrees Celsius at atmospheric pressure in the presence of a catalyst. The Biobased Value (BV) based on ASTM-D6866 method is 22%.

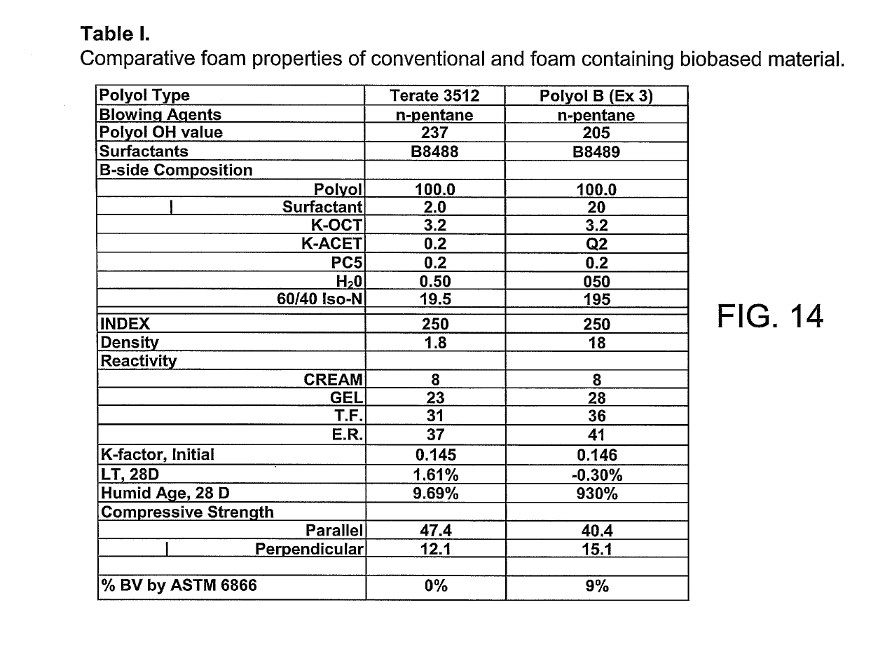

In another example below, an aromatic polyester polyol with higher levels of TOFA is provided. The corresponding aromatic polyester polyol is blended with fire retardant package, known in the art, to make a polyol having a Biobased Value (BV) of about 26%. A foam prepared from this polyol exhibits a Biobased Value of 9% according to ASTMD6866. As shown in Table I (FIG. 14) below, the foam properties are comparable to that of a foam system which contained 0% biobased value.

Herein, the renewable or biobased component is allowed to react and thereby become a part of the aromatic ester polymer chain. In a polymer system of PIR (polyisocyanurate) prepared at an index of 2.5, the base aromatic polyester polyol containing about 23-28% BV will provide a foam system with a minimum % BV of 7%. An alternative approach for a foam formulator seeking to provide a foam having a 7% minimum BV, is to use conventional polyols, e.g., Terate® polyol 3510, or Terate® polyol 3512, (INVISTA S.à r.l.), post-blended with hydroxyl-containing natural oil or modified natural oil. An advantage obtained by the use of aromatic polyester polyols containing renewable (biobased) material reacted with the aromatic ester linkages is believed to be the stabilization of the polyol-pentane blend. This advantage is obtained even in the absence of a surfactant.

Table II (FIG. 14) below shows the comparative compatibility of aromatic polyester polyols (APP) with renewable (biobased) material reacted into the aromatic ester linkages versus APP blends with castor oil. The mixture of APP polyol from Example 2 below and a pentane blowing agent results in a single phase liquid, whereas pentane solution of conventional APP blended with castor oil results in multiphase layers.

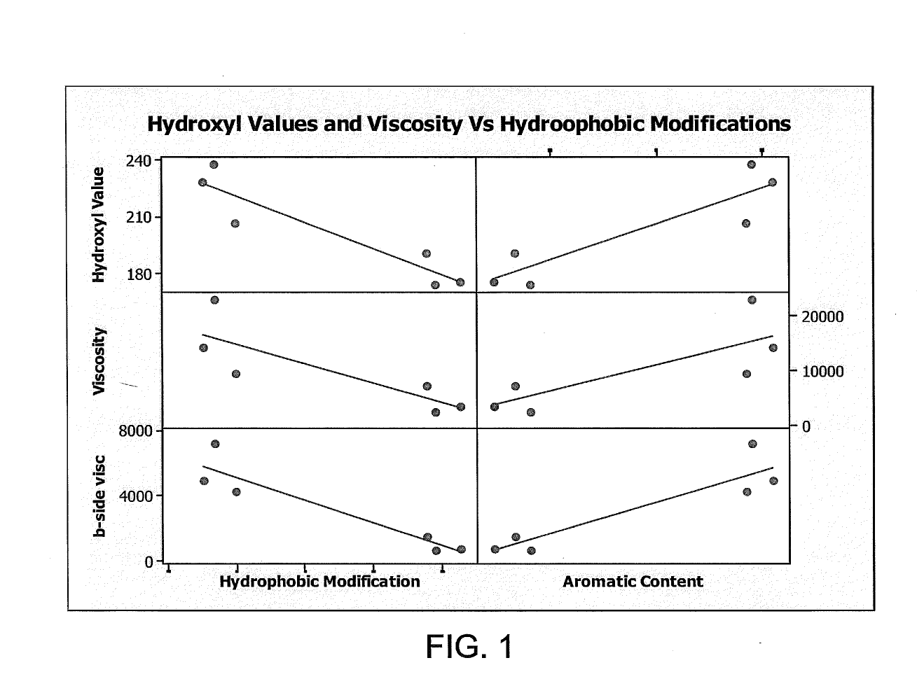

The modification of an aromatic polyester polyol with aliphatic and/or hydrophobic modifier from renewable (biobased) sources yields both negative and positive attributes to the foam system. FIGS. 1-4 illustrate some of the advantages of hydrophobic and/or aliphatic modification such as modification with biobased and/or nonbiobased raw material:

1) Modifications of aromatic polyester polyol with renewable products such as TOFA, soybean oil, lend to lower viscosity polyols and consequently lower viscosity b-side. This feature is illustrated in FIG. 1.

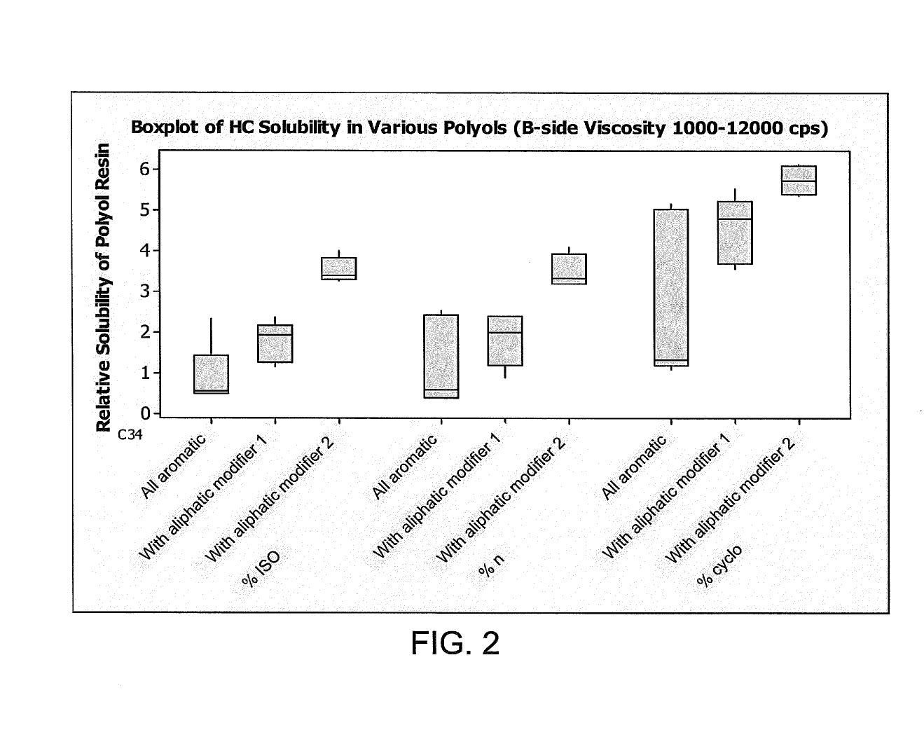

2) In general, modifications with aliphatic raw material lend to higher solubility of pentane with the polymer. Modification with renewable components, however leads higher blowing agent (pentane) compatibility as shown in FIG. 2. Aliphatic Modifier 2 in FIG. 2 is based on a nonedible plant based renewable content, whereas Aliphatic Modifier 1 is not a renewable material.

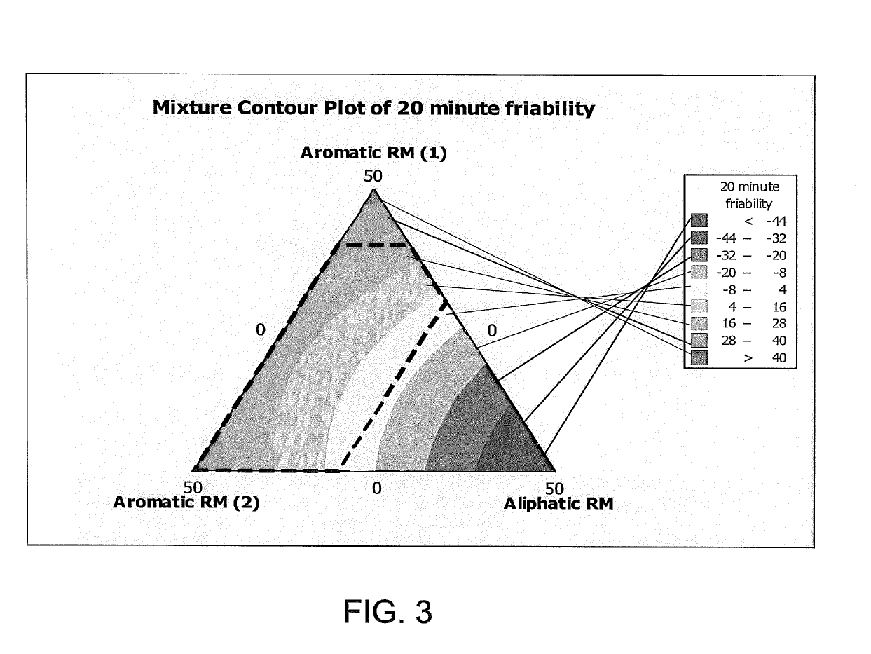

3) Higher levels of aliphatic modifications lead to better adhesion based on lower measured surface friability of foams made with polyols containing higher levels of aliphatic modifier (see FIG. 3.)

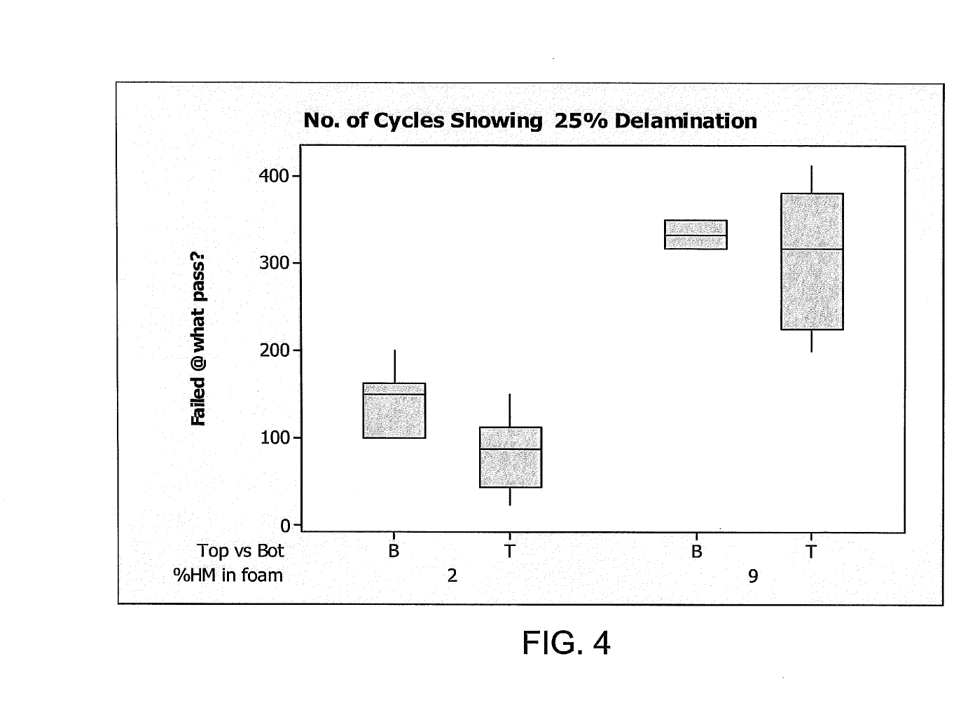

It is apparent from FIGS. 1-3 that the modification of APP with renewable (biobased) feedstock will generally improve the flowability/processability and pentane compatibility with aromatic polyester polyol. In addition, higher levels of hydrophobic modification (% HM) in the foam shows board stock with improved adhesion properties (see FIG. 4).

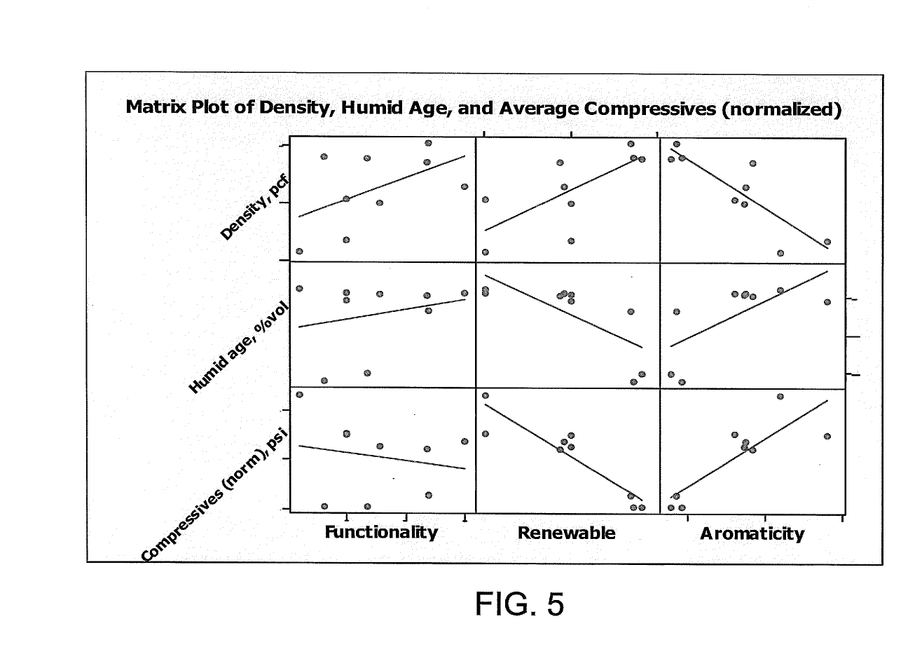

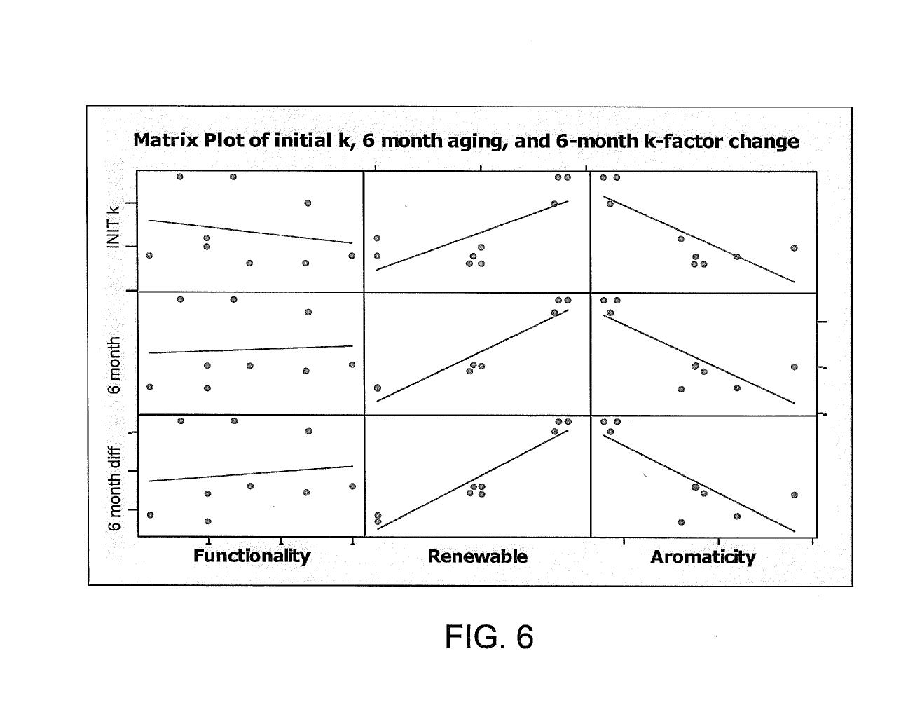

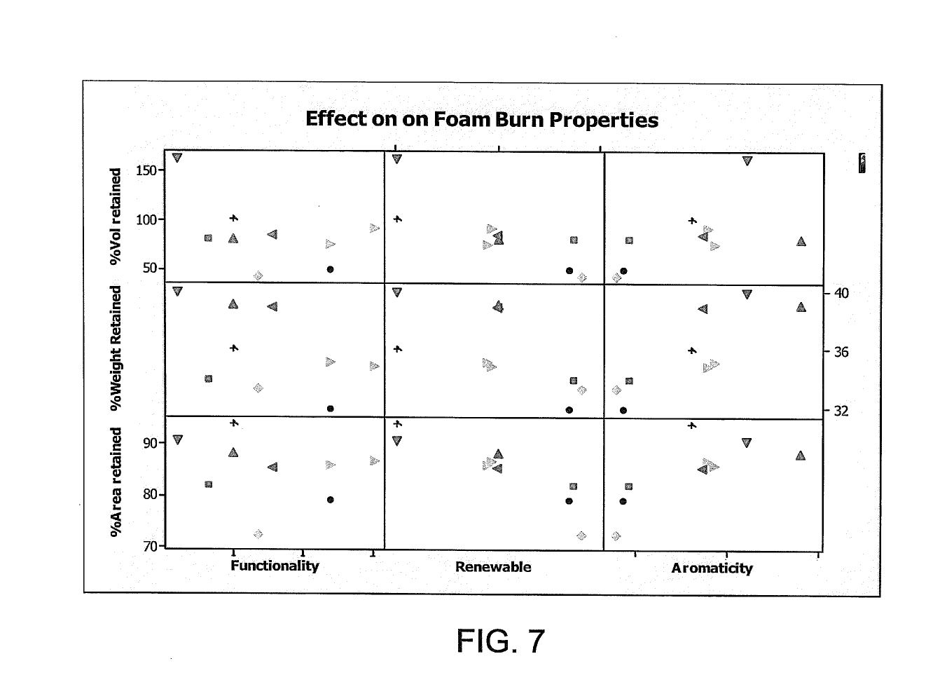

A deterioration in some properties of the boardstock foam with the replacement of the aromatic components of APP with hydrophobic modifier such as natural oils and other renewable materials is observable. For instance, the presence of higher levels of renewable material in APP lends to blowing agent inefficiencies as shown in FIG. 5. There is a statistical correlation between degree of modification of aromatic polyester polyol with renewable content and loss of mechanical, thermal insulation and burn properties in the foam. These relationships are shown in FIGS. 5-7. One mitigates these issues by increasing foam density and/or increasing formulation index. Herein, the use of high iso-pentane or exclusively iso-pentane blowing agents improves the performance of foams made from aromatic polyester polyols with renewable material reacted in the backbone. In an embodiment, the blowing agent comprises from 50 to 100 weight percent iso-pentane.

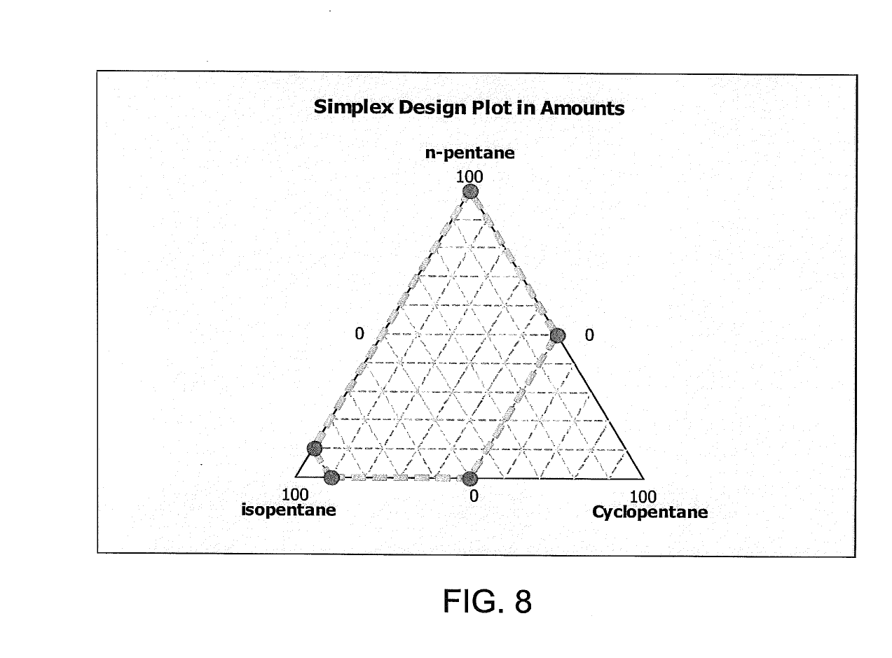

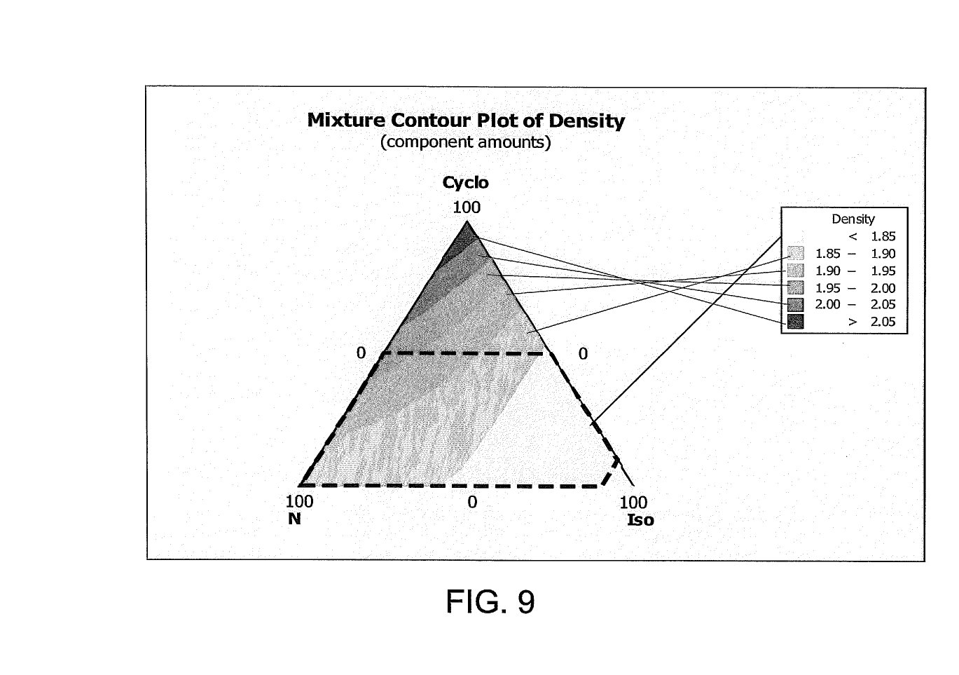

A designed study of blowing agent was carried out on APP containing 26% BV, similar to the polyol in Example 2. The simplex design from the study is represented in FIG. 8, and the comparative data of laboratory generated foams made with different blowing agents using Polyol A are summarized in Table III and FIGS. 9-11.

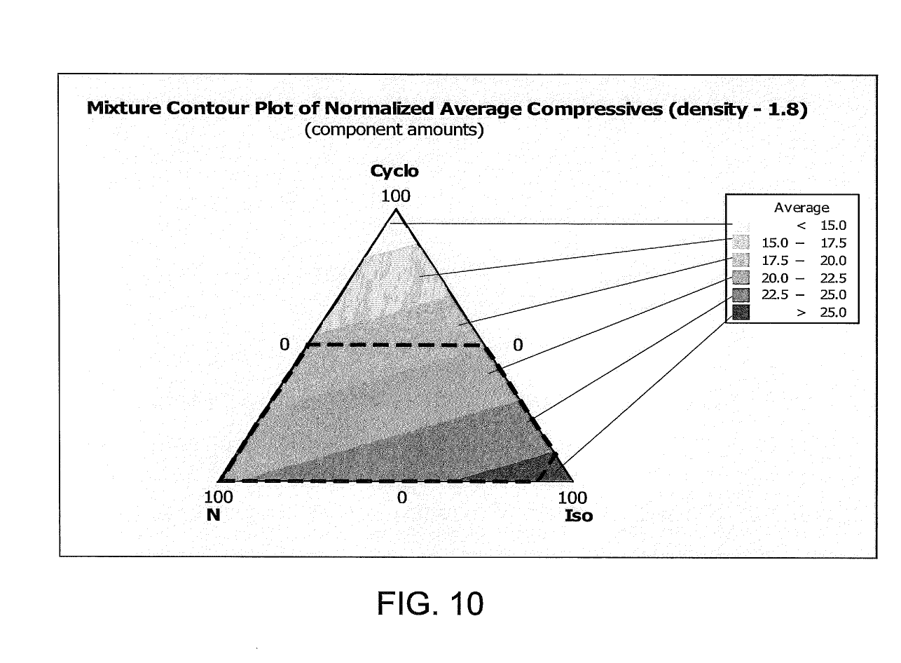

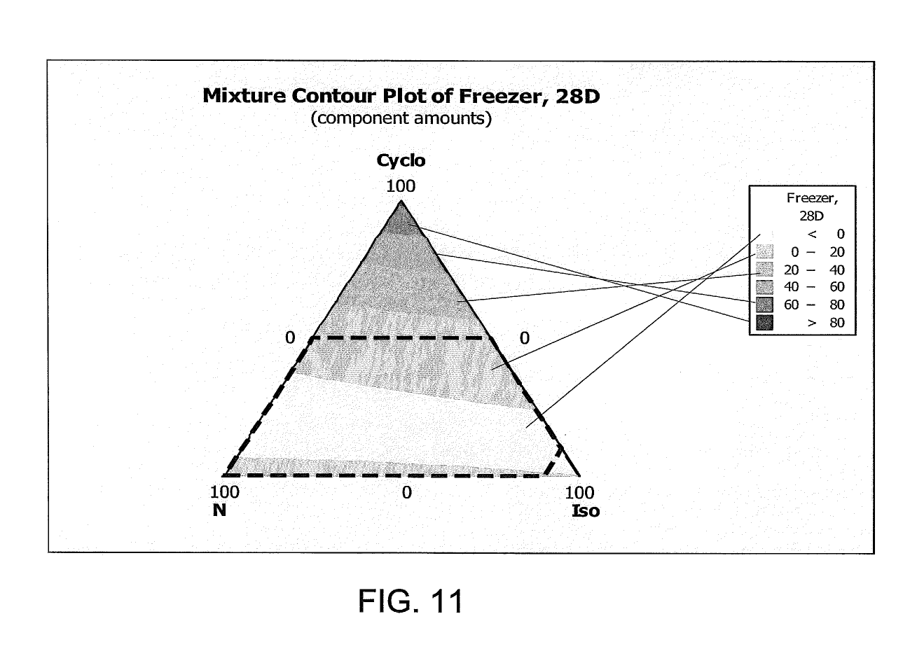

Based on these data, it is inferred that iso-pentane enriched formulation with and without water provides optimum conditions when using APP with renewable material in boardstock applications. Measured improvements when using high iso-pentane include: blowing agent efficiency (represented in FIG. 9); better compressives (represented in FIG. 10); and better dimensional stability (represented in FIG. 11).

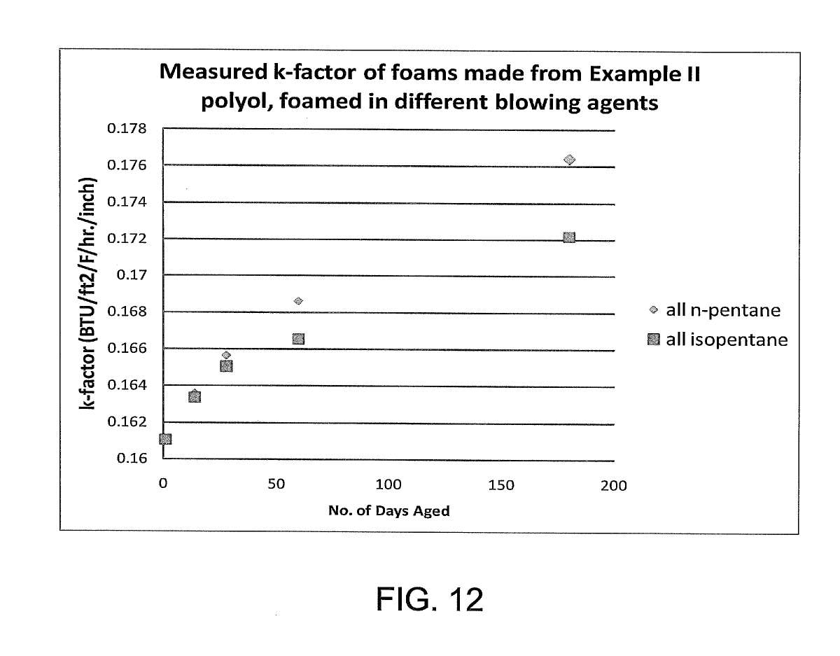

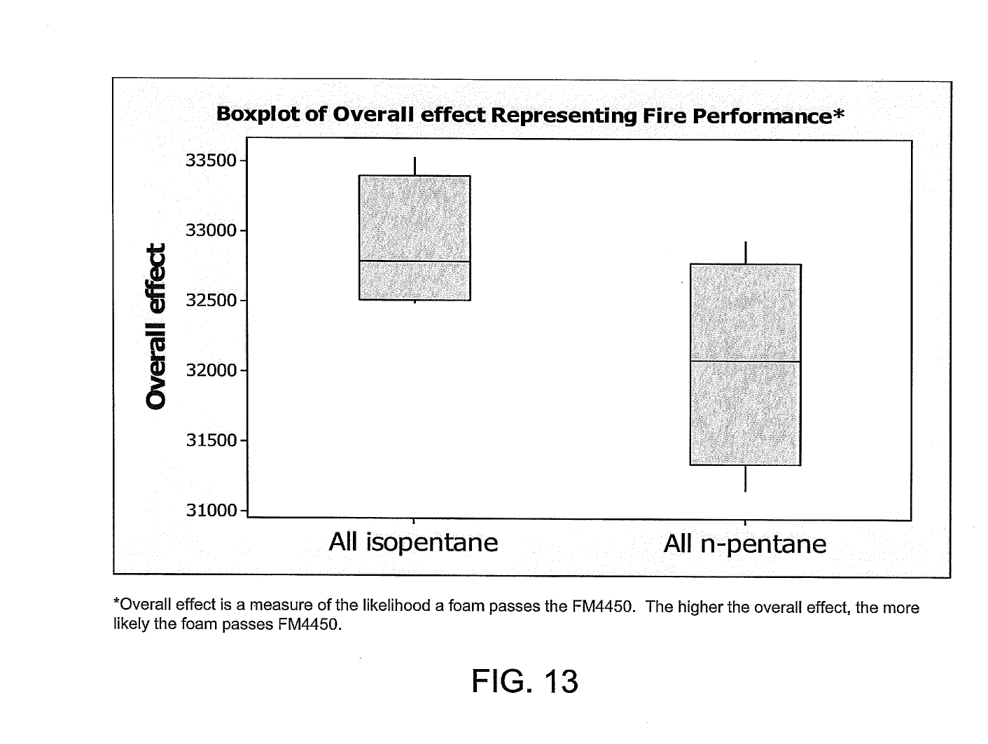

The improvement in “aged k-factor” and fire performance when using high iso-pentane was confirmed with foams generated from test laminations (see FIGS. 12 and 13). Aging of the boardstock foam made from aromatic polyester polyols containing 26% BV is less at 6 months when using exclusively iso-pentane as the blowing agent versus using exclusively n-pentane.

### Materials and Additional Test Methods

The following materials are used in the examples:

Dimethyl ester, manufactured from the byproducts of 1,4-benzenedicarboxylic acid—an aromatic feedstock used to make TERATE® polyols from INVISTA S.à r.l.

Tall oil fatty acid is available from Georgia Pacific. Polymer grade diethylene glycol (>99%) was obtained from Equistar. Pentane Isomers blowing agents are available from Exxon Chemical Company and/or Phillips Chemical Company.

TCPP or Tri(beta-chloro)phosphate (% P=9.5) is available from Albemarle Corporation.

Mondur 489 is a high functionality polymeric MDI available from Bayer Material Science.

TEGOSTAB® surfactants are silicone based surfactant available from Evonik Goldschmidt Corporation.

Catalysts such as Dabco® K-15, Polycat® 46, and Polycat® 5 are available from AirProducts, Inc.

The polyols were characterized for acidity, hydroxyl values, and viscosities at 25° C. The total acid number (AN) and hydroxyl values (OH) were determined by using the standard titration methods. Dynamic viscosity measurements were done at 25° C. on a Brookfield viscometer.

Foams presented in this application were generated via handmix preparations. Various foams were also generated from test laminations. Foam performance was monitored using procedures set forth in:

ASTM C-518 (K-factor)

ASTM D-6226 (closed cell content)

ASTM D-2126 (dimensional stability)

ASTM D-1622 (density)

ASTM D-1621 (compressive strength)

Calorimeter testing procedures are according to the reference: Dowling, K. C., Feske, E. F., Proceedings of the SPI Polyurethane Conference 1994, pp. 357-363.

ASTM Standard D6866-08, “Standard Test Methods for Determining the Biobased Content of Solid, Liquid, and Gaseous Samples Using Radiocarbon Analysis,” ASTM International, West Conshohocken, Pa., 2008, DOI: 10.1520/06866-08, www.astm.org.

The results provided herein refer to the biobased component present in the material and not the amount of biobased used in the manufacturing process.

### Example I

11 357 grams of diethylene glycol, 5591 grams of TOFA, 11 672 grams of dimethyl ester, manufacturing byproducts from 1,4-benzenedicarboxylic acid (Stream 1) were added to 30 liter reactor equipped with an agitator, reflux condenser, separation column, overhead receiver, and a thermocouple. In the presence of a catalyst, the reaction mixture was taken to a maximum temperature of 235° C. with constant agitation at atmospheric pressure, until theoretical overheads obtained. The acid number of the polyol was lowered using means known to the skilled person. The resulting polyol was characterized by determining hydroxyl number, acid number and viscosity at 25° C. The analysis of the final product is as follows: OH Value=220 mg KOH/gram, AN<1 mg KOH/gram, viscosity=2000 cps @25° C. The Biobased Value (BV) according to ASTM-D6866 was 22%.

### Example II

10 947 of diethylene glycol, 6427 grams of TOFA, 11 871 grams of dimethyl ester, manufacturing byproducts from 1,4-benzenedicarboxylic acid (Stream 2) were added to 30 liter reactor equipped with an agitator, reflux condenser, separation column, overhead receiver, and a thermocouple. In the presence of a catalyst, the reaction mixture was taken to a maximum temperature of 235° C. with constant agitation at atmospheric pressure, until theoretical overheads obtained. The acid number of the polyol was lowered by means known to the skilled person. The resulting polyol was characterized by determining hydroxyl number, acid number, and viscosity at 25° C. About 7-12% of a flame retardant package was added to the resulting polyol (Polyol A). The final product analyses of Polyol A were: OH value=198 mg KOH/gram, AN value=0.7 mg KOH/gram, viscosity at 25° C.=1830 cps. The Biobased Value (% BV) according to ASTM-D6866 was 26%.

### Example III

11 286 grams of diethylene glycol, 7432 grams of TOFA, 11 285 grams of DMT (dimethylterephthalate) residue Stream 3 were added to 30 liter reactor equipped with an agitator, reflux condenser, separation column, overhead receiver, and a thermocouple. In the presence of a catalyst, the reaction mixture was run to a top temperature of 235° C. with constant agitation at atmospheric pressure, until the theoretical overheads were obtained. The acid number of the polyol was lowered using means known to the skilled person. The resulting polyol was characterized by determining hydroxyl number, acid number, and viscosity at 25° C. About 7-12% of flame retardant package was added to the resulting polyol (Polyol B). The final product analyses of Polyol B were: OH value=205 mg KOH/gram, AN value=1 mg KOH/gram, viscosity at 25° C.=1740 cps. Polyol B was then reacted with MDI based on the formulation shown below. The Biobased Value (BV %) of the resulting foams according to ASTM-D6866 was 9%.

The ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

What is claimed:

1. A polyurethane or polyisocyanurate board stock foam having a biobased content of 7% or greater as measured by ASTM D6866, the foam comprising an aromatic polyol provided by the reaction products of:
a) a first composition comprising a hydroxylated material, wherein the hydroxylated material is at least difunctional;
b) a second composition selected from the group consisting of: terephthalic acid, an ester of terephthalic acid, isophthalic acid, an ester of isophthalic acid, orthophthalic acid, an ester of orthophthalic acid, trimellitic acid, an ester of trimellitic acid, orthophthalic anhydride, an ester of orthophthalic anhydride, trimellitic anhydride, an ester of trimellitic anhydride, and a mixture thereof; and
c) a third composition comprising of up to about 50% of a hydrophobic material, wherein the hydrophobic material is selected from the group consisting of: a nonedible plant derived oil, a nonedible animal derived oil, a fatty acid of a nonedible plant oil, a fatty acid of an animal derived oil, an ester of a nonedible plant oil, an ester of a nonedible animal derived oil, and a mixture thereof.

2. The board stock foam of claim 1, further comprising a blowing agent containing from about 50 to 100 weight percent isopentane.

3. The board stock foam of claim 1, wherein the third composition is selected from the group consisting of: tallow oil, castor oil, linseed oil, and a combination thereof.

4. The board stock foam of claim 1, wherein the second composition is selected from the group consisting of: terephthalic acid, an ester of terephthalic acid, isophthalic acid, an ester of isophthalic acid, orthophthalic acid, an ester of orthophthalic acid, trimellitic acid, an ester of trimellitic acid, orthophthalic anhydride, an ester of orthophthalic anhydride, trimellitic anhydride, an ester of trimellitic anhydride, and a mixture thereof.

5. The board stock foam of claim 1, wherein the foam further comprises a reaction product with hydroxylated crosslinkers, wherein the reaction product is selected from the group consisting of: glycerin, trimethylol, pentaerythritol, sucrose, sorbitol, and a combination thereof.

6. The board stock foam of claim 1, wherein the foam further comprises a reaction product with aliphatic acids, aliphatic esters, or a combination thereof, wherein the reaction product is selected from the group consisting of: succinic acid, glutaric acid, adipic acid, an ester of each of these, and a mixture thereof.

7. The board stock foam of claim 1, wherein the foam further comprises a reaction product of the hydroxylated crosslinkers with aliphatic acids, aliphatic esters, or a combination thereof, wherein the reaction product is selected from the group consisting of: succinic acid, glutaric acid, adipic acid, an ester of each of these, and a mixture thereof.

8. A polyol composition comprising an aromatic polyol provided by the reaction products of:
a) a first composition comprising a hydroxylated material, wherein the hydroxylated material is at least difunctional;
b) a second composition selected from the group consisting of: terephthalic acid, an ester of terephthalic acid, isophthalic acid, an ester of isophthalic acid, orthophthalic acid, an ester of orthophthalic acid, trimellitic acid, an ester of trimellitic acid, orthophthalic anhydride, an ester of orthophthalic anhydride, trimellitic anhydride, an ester of trimellitic anhydride, and a mixture thereof; and
c) a third composition comprising of up to about 50% of a hydrophobic material, wherein the hydrophobic material is selected from the group consisting of: a nonedible plant derived oil, a nonedible animal derived oil, a fatty acid of a nonedible plant oil, a fatty acid of an animal derived oil, an ester of a nonedible plant oil, an ester of a nonedible animal derived oil, and a mixture thereof.

9. The polyol composition of claim 1, further comprising the third composition selected from the group consisting of: tallow oil, castor oil, linseed oil, and a combination thereof.

10. A resin blend composition comprising: a polyol of any of claims 8 and 9; a surfactant; a catalyst and a blowing agent.

11. The resin blend composition of claim 10, wherein the third composition is selected from the group consisting of: tallow oil, castor oil, linseed oil, and a combination thereof.

12. The resin blend composition of claim 10, wherein the blowing agent contains about 50 to 100 weight percent isopentane.

13. A board stock foam composition comprising a reaction product of the resin blend composition of any of claims 10 to 12 with a polyfunctional isocyanate.

14. The board stock foam composition of claim 13, having a biobased content of 7% or greater as measured by ASTM D6866.
